(19) United States
(12) Patent Application Publication
(10) Pub. No.: US 2026/0008160 A1
(43) Pub. Date: Jan. 8, 2026

(54) MOUNTING ASSEMBLY FOR DETACHABLY FIXING A BIT

(71) Applicant: Nanjing Chervon Industry Co., Ltd., Nanjing (CN)

(72) Inventor: Rui Xu, Nanjing (CN)

(21) Appl. No.: 19/228,315

(22) Filed: Jun. 4, 2025

(30) Foreign Application Priority Data
Jul. 2, 2024 (CN) 202410884306.1

(51) Int. Cl. B25B 23/00; B25B 21/02

(52) U.S. Cl. CPC B25B 23/0035; B25B 21/02

(57) ABSTRACT

A mounting assembly includes a base including an axial opening for receiving a bit and a first circular hole and a second circular hole that are defined on a wall of the axial opening; a first retainer configured to move radially in the first circular hole; a second retainer configured to move radially in the second circular hole, where the second retainer has a greater volume than the first retainer; a sleeve sleeved on the periphery of the base and including an inclined surface, where when the inclined surface is pressed against, the sleeve moves axially relative to the base; and a biasing element disposed between the base and the sleeve to bias the sleeve in position.

### RELATED APPLICATION INFORMATION

This application claims the benefit under 35 U.S.C. § 119 (a) of Chinese Patent Application No. CN 202410884306.1, filed on Jul. 2, 2024, which application is incorporated herein by reference in its entirety.

### TECHNICAL FIELD

The present application relates to a power tool and, in particular, to a mounting assembly for detachably fixing a bit.

### BACKGROUND

Handheld power tools play a very important role in daily production and life. The handheld power tools include, but are not limited to, an electric hand drill, an impact drill, an impact wrench, an impact screwdriver, and an angle grinder. The electric hand drill and the impact drill may be equipped with drill bits of different diameters to drill holes in objects. The impact wrench is used for tightening bolts and nuts. The impact screwdriver is usually used for loosening or tightening screws. The angle grinder can grind and cut objects. The handheld power tools can improve working efficiency and reduce labor intensity.

In the process of twisting the screws of different types, the impact screwdriver requires the replacement with corresponding bits at any time. Therefore, the impact screwdriver typically enables a bit to be quickly replaced. However, in the existing art, a base of the impact screwdriver that mates with the bit is defined with two slotted holes, and balls roll in the slotted holes to mate with a groove on the bit so that the bit is clamped or released. In this manner, due to a relatively long length of the base, the impact screwdriver is inconvenient to carry and to use in a small space; meanwhile, the slotted holes on the base are defined by a relatively complex process and are relatively difficult to machine.

This part provides background information related to the present application, and the background information is not necessarily the existing art.

### SUMMARY

An object of the present application is to solve or at least alleviate part or all of the preceding problems.

To achieve the object, the present invention adopts the technical solutions below.

A mounting assembly for detachably fixing a bit includes a base, a first retainer, a second retainer, a sleeve, and a biasing element.

The base includes an axial opening for receiving a bit and a first circular hole and a second circular hole that are defined on a wall of the axial opening.

The first retainer is configured to move radially in the first circular hole.

The second retainer is configured to move radially in the second circular hole, and the second retainer has a greater volume than the first retainer.

The sleeve is sleeved on the periphery of the base and includes an inclined surface, where when the inclined surface is pressed against, the sleeve moves axially relative to the base.

The biasing element is disposed between the base and the sleeve to bias the sleeve in position.

The axial length of the base is less than or equal to 32 mm.

In some examples, the axial length of the base is greater than or equal to 27 mm and less than or equal to 31 mm.

In some examples, the first retainer is configured to, when the bit is inserted into the axial opening, move outward and press against the inclined surface to move the sleeve.

In some examples, the second retainer is configured to, after the bit is inserted into the axial opening, move inward and abut against a groove on the bit to lock the bit.

In some examples, the sleeve includes a locking surface connected to the inclined surface, and after the bit is inserted into the axial opening, the locking surface is able to prevent the second retainer from moving outward.

In some examples, after the bit is inserted into the axial opening, the biasing element resets the sleeve.

In some examples, the shortest distance between the first circular hole and an open end of the axial opening is less than the shortest distance between the second circular hole and the open end of the axial opening.

In some examples, when the sleeve is pulled manually, the second retainer and the first retainer are movable radially so that the bit is pullable out.

In some examples, a bit ejection mechanism is provided in the axial opening, and the bit ejection mechanism is able to eject the bit through a set distance relative to an open end of the axial opening.

In some examples, the width of a groove on the bit is greater than the diameter of the first circular hole and the diameter of the second circular hole.

A mounting assembly for detachably fixing a bit includes a base, a first retainer, a second retainer, a sleeve, and a biasing element.

The base includes an axial opening for receiving a bit and a first circular hole and a second circular hole that are defined on a wall of the axial opening.

The first retainer is configured to move radially in the first circular hole.

The second retainer is configured to move radially in the second circular hole.

The sleeve is sleeved on the periphery of the base and includes an inclined surface, where when the inclined surface is pressed against, the sleeve moves axially relative to the base.

The biasing element is disposed between the base and the sleeve to bias the sleeve in position.

When the bit is locked in the axial opening, the first retainer and the second retainer are at least partially retained in a groove on the bit.

In some examples, the first retainer and the second retainer are spheres, and the second retainer has a greater diameter than the first retainer.

In some examples, the biasing element biases the sleeve in an opposite direction of the axial opening.

In some examples, the first retainer is configured to, when the bit is inserted into the axial opening, move outward and press against the inclined surface to move the sleeve.

In some examples, the second retainer is configured to, after the bit is inserted into the axial opening, move inward and abut against the groove on the bit to lock the bit.

In some examples, the sleeve includes a locking surface connected to the inclined surface, and after the bit is inserted into the axial opening, the locking surface is able to prevent the second retainer from moving outward.

In some examples, after the bit is inserted into the axial opening, the biasing element resets the sleeve.

In some examples, the shortest distance between the first circular hole and an open end of the axial opening is less than the shortest distance between the second circular hole and the open end of the axial opening.

In some examples, when the sleeve is pulled manually, the second retainer and the first retainer are movable radially so that the bit is pullable out.

In some examples, the axial length of the base is less than or equal to 32 mm.

A mounting assembly for detachably fixing a bit includes a base, a first retainer, a second retainer, a sleeve, and a biasing element.

The base includes an axial opening for receiving a bit and a first circular hole and a second circular hole that are defined on a wall of the axial opening.

The first retainer is configured to move radially in the first circular hole.

The second retainer is configured to move radially in the second circular hole.

The sleeve is sleeved on the periphery of the base and includes an inclined surface, where when the inclined surface is pressed against, the sleeve moves axially relative to the base.

The biasing element is disposed between the base and the sleeve to bias the sleeve in position.

During the insertion of the bit into the axial opening, the first retainer moves outward and presses against the inclined surface to move the sleeve; and after the bit is completely inserted into the axial opening, the biasing element resets the sleeve.

In some examples, the first retainer and the second retainer are spheres, and the second retainer has a greater diameter than the first retainer.

In some examples, the biasing element biases the sleeve in an opposite direction of the axial opening.

In some examples, the second retainer is configured to, after the bit is inserted into the axial opening, move inward and abut against a groove on the bit to lock the bit.

In some examples, the sleeve includes a locking surface connected to the inclined surface, and after the bit is inserted into the axial opening, the locking surface is able to prevent the second retainer from moving outward.

In some examples, the shortest distance between the first circular hole and an open end of the axial opening is less than the shortest distance between the second circular hole and the open end of the axial opening.

In some examples, when the sleeve is pulled manually, the second retainer and the first retainer are movable radially so that the bit is pullable out.

In some examples, the width of a groove on the bit is greater than the diameter of the first circular hole and the diameter of the second circular hole.

In some examples, the axial length of the base is less than or equal to 32 mm.

In some examples, a bit ejection mechanism is provided in the axial opening, and the bit ejection mechanism is able to eject the bit through a set distance relative to an open end of the axial opening.

The present application has the benefits below.

In the mounting assembly for detachably fixing a bit of the present application, the axial opening is opened on the base, the first circular hole and the second circular hole are defined on the wall of the axial opening, the first retainer can move radially in the first circular hole, and the second retainer can move radially in the second circular hole. The sleeve is sleeved on the periphery of the base. The bit mates with the first retainer, the second retainer, and the sleeve so that the bit is locked or unlocked in the axial opening of the base. The first circular hole and the second circular hole are defined on the base to replace the original slotted holes, facilitating machining and reducing a machining difficulty. Moreover, in the form of circular holes, the first retainer and the second retainer move radially in the first circular hole and the second circular hole instead of moving axially so that the length of the base can be reduced, facilitating carrying and use in a narrow space.

### BRIEF DESCRIPTION OF THE DRAWINGS

FIG. 1 is a front view of an impact screwdriver.

FIG. 2 is a top view of an impact screwdriver.

FIG. 3 is a sectional view of FIG. 2 along A-A.

FIG. 4 is a right view of an impact screwdriver.

FIG. 5 is a sectional view of FIG. 4 along B-B.

FIG. 6 is a view illustrating a mounting assembly for detachably fixing a bit.

FIG. 7 is an exploded view of a mounting assembly for detachably fixing a bit.

FIG. 8 is a front view of a mounting assembly for detachably fixing a bit.

FIG. 9 is a sectional view of FIG. 8 along C-C.

FIG. 10 is a view illustrating that a bit is inserted into a mounting assembly for detachably fixing a bit.

FIG. 11 is a sectional view of FIG. 10 along D-D.

FIG. 12 is a view illustrating that a bit is locked in a mounting assembly for detachably fixing a bit.

FIG. 13 is a sectional view of FIG. 12 along E-E.

FIG. 14 is a view illustrating that unlocking is performed by a sleeve in a mounting assembly for detachably fixing a bit.

FIG. 15 is a sectional view of FIG. 14 along F-F.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

Handheld power tools play a very important role in daily production and life. The handheld power tools include, but are not limited to, an electric hand drill, an impact drill, an impact wrench, an impact screwdriver, and an angle grinder. It is to be understood that in other alternative examples, different working accessories may be mounted to a handheld power tool. The handheld power tool with one of these different working accessories may be the impact drill or the impact screwdriver.

In some examples, the handheld power tool includes a power supply for supplying electrical energy to the handheld power tool. In some examples, the handheld power tool is powered by a direct current power supply. In some examples, the power supply is a battery pack, and the battery pack in cooperation with a corresponding power supply circuit powers electrical elements in the handheld power tool. It is to be understood by those skilled in the art that the power supply is not limited to the battery pack, and circuit elements may also be powered by mains power, an alternating current power supply, or a combination of mains power and the battery pack in conjunction with the corresponding rectifier circuit, filter circuit, and voltage regulator circuit.

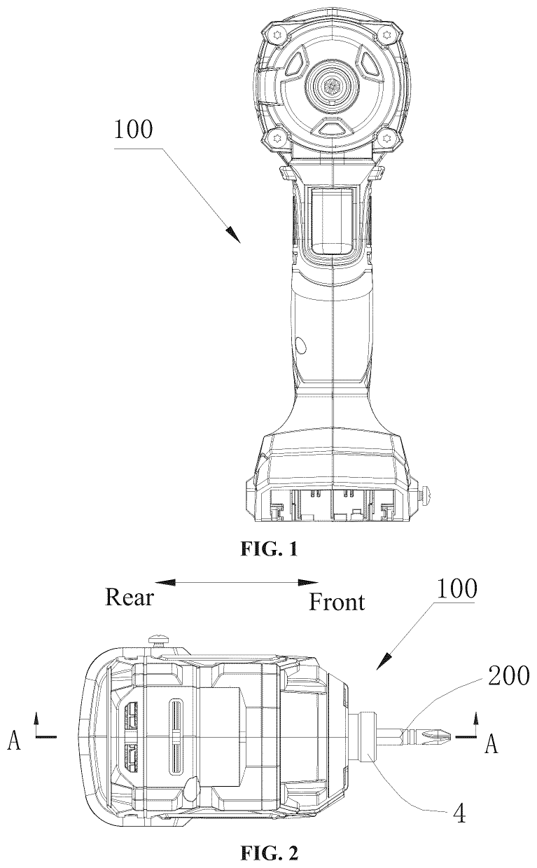

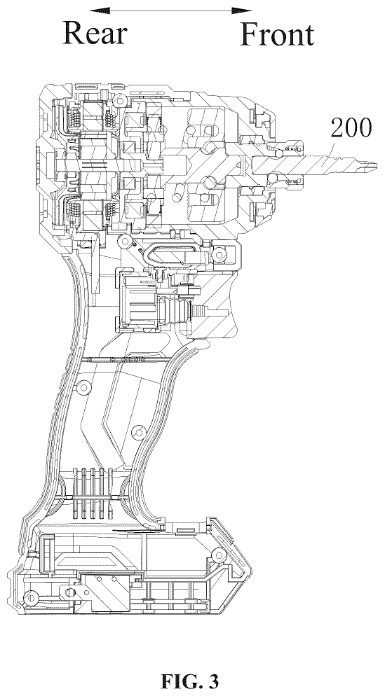

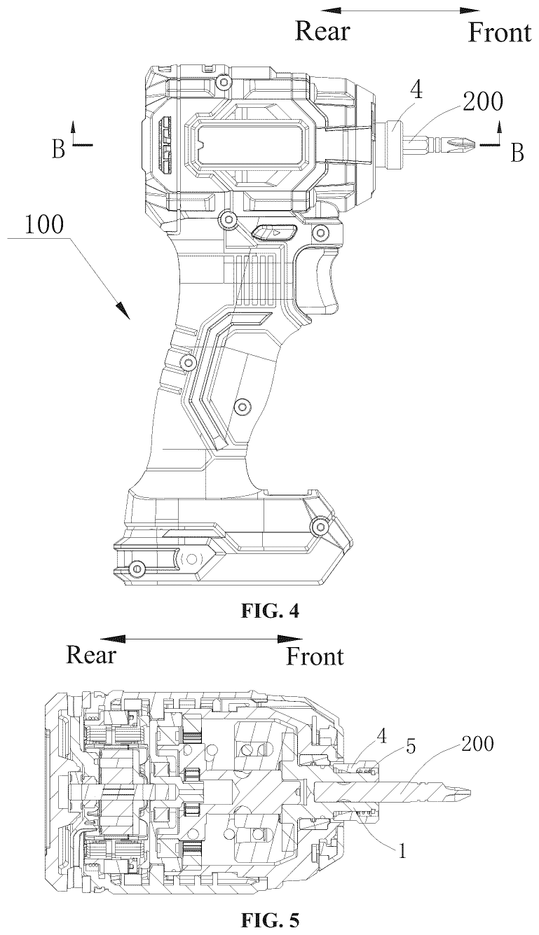

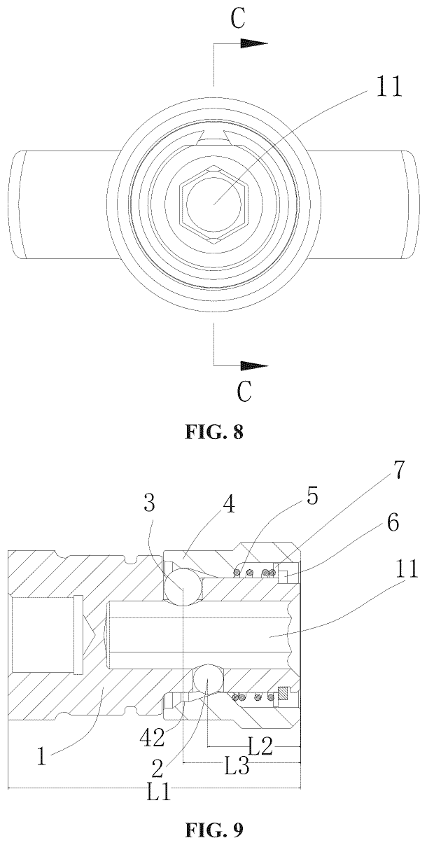

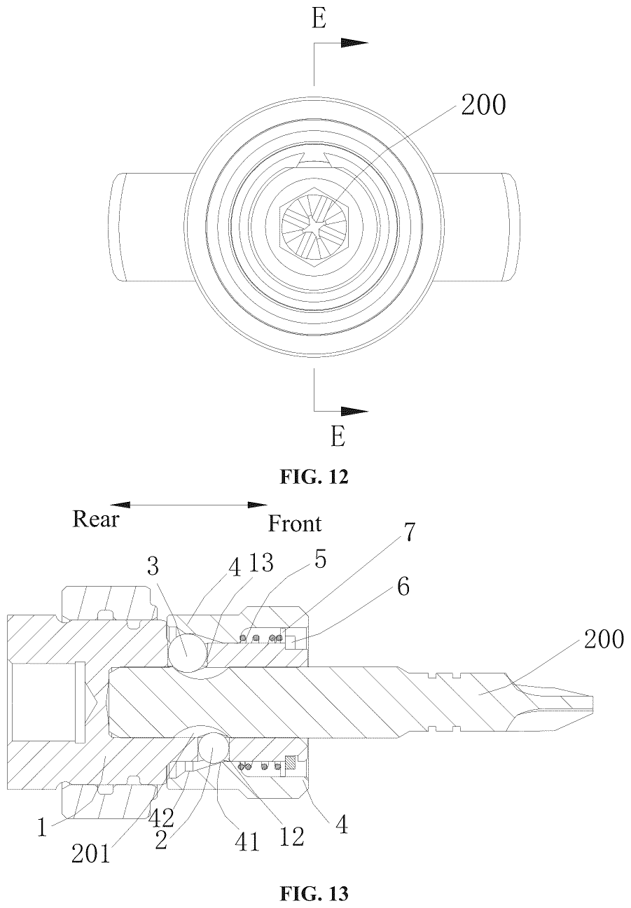

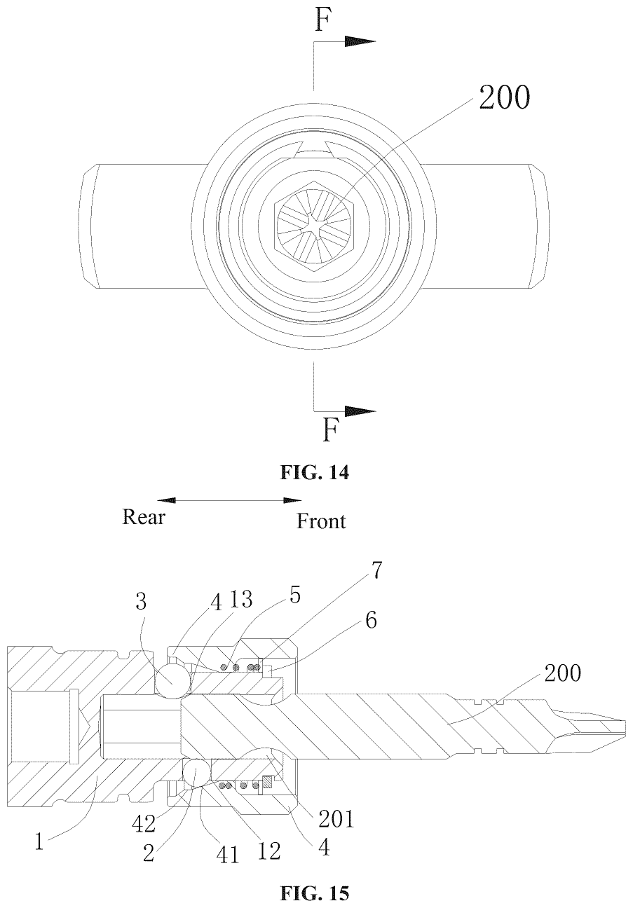

In the case where the handheld power tool is the impact screwdriver, in the existing art, balls roll in slotted holes to mate with a groove on a bit so that the bit is clamped or released, thereby implementing the function of quickly clamping or releasing the bit. In this manner, due to a relatively long length of a base, the impact screwdriver is inconvenient to carry and to use in a small space; meanwhile, the slotted holes on the base are defined by a relatively complex process and are relatively difficult to machine. To solve the preceding problems, as shown in FIGS. 1 to 15, the present application provides a mounting assembly for detachably fixing a bit. The mounting assembly includes a base 1, a first retainer 2, a second retainer 3, a sleeve 4, and a biasing element 5.

As shown in FIGS. 9 and 11, the axial length L1 of the base 1 is less than or equal to 32 mm, and the base 1 includes an axial opening 11 for receiving a bit 200 and a first circular hole 12 and a second circular hole 13 that are defined on a wall of the axial opening 11, where the first circular hole 12 and the second circular hole 13 each communicate with the axial opening 11. The first retainer 2 is configured to move radially in the first circular hole 12; the second retainer 3 is configured to move radially in the second circular hole 13, and the second retainer 3 has a greater volume than the first retainer 2. The sleeve 4 is sleeved on the periphery of the base 1, and the sleeve 4 includes an inclined surface 41. When the inclined surface 41 is pressed against, the sleeve 4 moves axially relative to the base 1. The biasing element 5 is disposed between the base 1 and the sleeve 4 to bias the sleeve 4 in position. In some examples, the base 1 is an output shaft of an impact screwdriver 100, the bit 200 is mounted on the base 1, and the base 1 is driven by an electric motor to rotate to drive the bit 200 to rotate, so as to twist a screw.

The first circular hole 12 and the second circular hole 13 are defined on the base 1 to replace the original slotted holes, facilitating machining and reducing a machining difficulty. Moreover, in the form of circular holes, the first retainer 2 and the second retainer 3 move radially in the first circular hole 12 and the second circular hole 13 instead of moving axially so that the length of the base 1 can be reduced, facilitating carrying and use in a narrow space.

As shown in FIG. 9, in some examples, the axial length L1 of the base 1 is greater than or equal to 27 mm and less than or equal to 31 mm. The axial length L1 of the base 1 may be 27 mm, 28 mm, 29 mm, 30 mm, or 31 mm. In other examples, the axial length L1 of the base 1 is greater than or equal to 31 mm and less than or equal to 35 mm. The axial length L1 of the base 1 may be 31 mm, 32 mm, 33 mm, 34 mm, or 35 mm. Alternatively, the axial length L1 of the base 1 may be greater than or equal to 22 mm and less than or equal to 27 mm. The axial length L1 of the base 1 may be 22 mm, 23 mm, 24 mm, 25 mm, 26 mm, or 27 mm. The axial length L1 of the base 1 is defined so that the compactness of the impact screwdriver 100 can be improved, facilitating carrying and storage. Moreover, the impact screwdriver can be used in a narrow space, flexibly satisfying use requirements on various occasions.

As shown in FIG. 11, in some examples, the first retainer 2 is configured to, when the bit 200 is inserted into the axial opening 11, move outward and press against the inclined surface 41 to move the sleeve 4. In some examples, the first retainer 2 is a sphere. During the insertion of the bit 200, under the action of the bit 200, the first retainer moves outward in a radial direction of the base 1 and presses against the inclined surface 41 of the sleeve 4 to push the sleeve 4 forward in a direction towards an open end of the axial opening 11. At the same time, the biasing element 5 is compressed. In this process, the second retainer 3 is in an unlocked state, and the second retainer 3 can move outward under the push of the bit 200, facilitating the insertion of the bit 200.

As shown in FIG. 13, in some examples, the second retainer 3 is configured to, after the bit 200 is inserted into the axial opening 11, move inward and abut against a groove 201 to lock the bit 200. After the bit 200 is inserted into place, the groove 201 of the bit 200 faces the second retainer 3, and the second retainer 3 automatically falls into the groove 201 and thus locks the bit 200. In this manner, a relative position between the bit 200 and the base 1 can be locked, and during the subsequent operation of the bit 200, the bit 200 does not fall out of the base 1, ensuring the stability of operation of the impact screwdriver 100.

As shown in FIG. 13, in some examples, the sleeve 4 includes a locking surface 42 connected to the inclined surface 41, and after the bit 200 is inserted into the axial opening 11, the locking surface 42 is able to prevent the second retainer 3 from moving outward. The locking surface 42 is a horizontal plane. After the bit 200 is inserted into the axial opening 11, the second retainer 3 is at least partially located in the groove 201 of the bit 200. At this time, the sleeve 4 is reset, the locking surface 42 of the sleeve 4 abuts against the second retainer 3, and the locking surface 42 is a horizontal plane and thus prevents the second retainer 3 from moving in the radial direction of the base 1, thereby locking the position of the bit 200 relative to the base 1.

As shown in FIGS. 7 and 13, in some examples, after the bit 200 is inserted into the axial opening 11, the biasing element 5 resets the sleeve 4. The biasing element 5 may be a compression spring. During the insertion of the bit 200, the first retainer 2 is pushed by the bit 200 to move outward along the radial direction of the base 1 and press against the inclined surface 41 to drive the sleeve 4 to move forward and compress the biasing element 5. After the bit 200 is inserted into place in the axial opening 11, the biasing element 5 pushes the sleeve 4 to reset under the action of its own elastic restoring force, and the locking surface 42 of the sleeve 4 mates with the second retainer 3, thereby locking the bit 200. In this manner, after the bit 200 is mounted in place, the sleeve 4 automatically resets and mates with the second retainer 3 to lock the bit 200 so that the bit 200 can be quickly locked.

As shown in FIGS. 7 and 11, in some examples, to facilitate the mounting of the biasing element 5, a snap ring 6 and a washer 7 are sleeved on the base 1, the snap ring 6 and the washer 7 are located at the open end of the axial opening 11, one end of the biasing element 5 abuts against the sleeve 4, and the other end of the biasing element 5 abuts against the washer 7. During the mounting of the biasing element 5, the sleeve 4 is sleeved on the base 1, then the biasing element 5 is sleeved on the base 1 and compressed, and the washer 7 and the snap ring 6 are mounted on the base 1 so that the biasing element 5 can be mounted in place. The above structures facilitate the mounting and detachment of the biasing element 5.

As shown in FIGS. 9 and 11, in some examples, the shortest distance L2 between the first circular hole 12 and the open end of the axial opening 11 is less than the shortest distance L3 between the second circular hole 13 and the open end of the axial opening 11. The first retainer 2 can unlock the second retainer 3 as follows: the first retainer 2 mates with the inclined surface 41 and can push the sleeve 4 to move to release the second retainer 3 so that the second retainer 3 is pushed by the bit 200 to move outward along the radial direction of the base 1. Therefore, the above arrangement can ensure that the bit 200 first contacts and mates with the first retainer 2 and then contacts and mates with the second retainer 3, ensuring that the bit 200 is mounted smoothly.

As shown in FIG. 15, in some examples, when the sleeve 4 is pulled manually, the second retainer 3 and the first retainer 2 are movable radially so that the bit 200 can be pulled out. When the bit 200 needs to be replaced or removed, an operator manually pulls the sleeve 4 forward in the direction towards the open end of the axial opening 11, the locking surface 42 is disengaged from the second retainer 3, the second retainer 3 is released from a locked state, the second retainer 3 is driven by the bit 200 to move outward along the radial direction of the base 1, and the bit 200 is disengaged from the second retainer 3 so that the bit 200 is smoothly removed. In this manner, the bit 200 is convenient to remove, and the operation is simple.

In some examples, a bit ejection mechanism is provided in the axial opening 11, and the bit ejection mechanism is able to eject the bit 200 through a set distance relative to the open end of the axial opening 11. The bit ejection mechanism may be a compression spring. During the insertion of the bit 200, the bit ejection mechanism is compressed to store energy. After the bit 200 is unlocked, the bit ejection mechanism ejects the bit 200 under the action of its own resilient force so that the bit 200 is convenient to remove quickly.

As shown in FIG. 13, in some examples, the width of the groove 201 is greater than the diameter of the first circular hole 12 and the diameter of the second circular hole 13. With the above arrangement, after the bit 200 is inserted into place, the first retainer 2 and the second retainer 3 are at least partially located in the groove 201 and can effectively lock the bit 200.

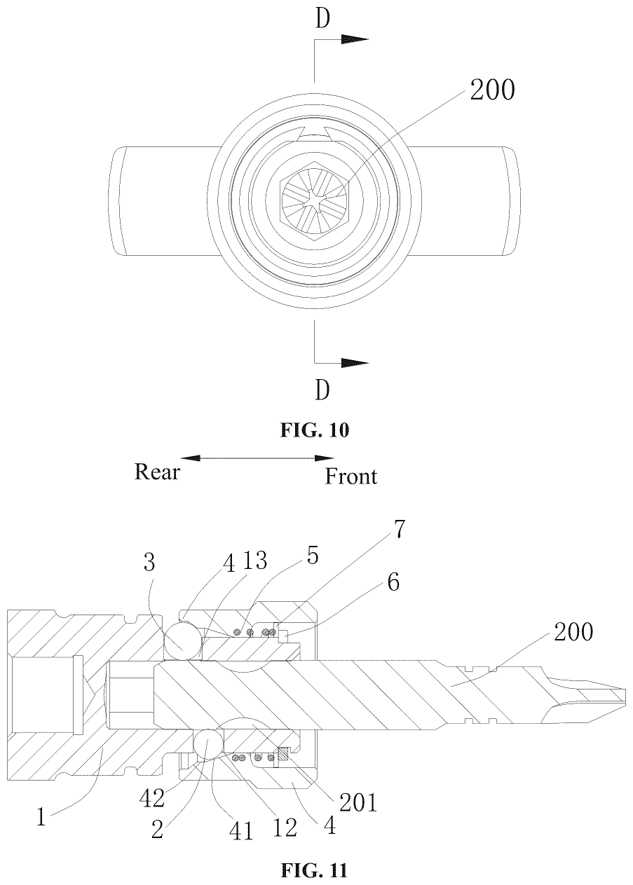

As shown in FIGS. 10 to 15, the processes of mounting and detaching the bit 200 by using the mounting assembly are described below.

When the bit 200 is inserted into the axial opening 11 of the base 1, the bit 200 first contacts the first retainer 2, the first retainer 2 presses against the inclined surface 41 of the sleeve 4 to push the sleeve 4 to move so that the second retainer 3 is released from the locked state, the bit 200 may continue to be inserted, and the second retainer 3 moves outward along the radial direction of the base 1 under the action of the bit 200. When the bit 200 is inserted to the bottom, due to the groove 201 on the bit 200, the bit 200 cannot continue to support the first retainer 2 and the second retainer 3, and the first retainer 2 and the second retainer 3 reset to lock the bit 200. At this time, the sleeve 4 automatically resets under the action of the biasing element 5, and the locking surface 42 of the sleeve 4 mates with the second retainer 3 to limit the position of the second retainer 3 so that the second retainer 3 locks the bit 200. When the bit 200 is forcefully pulled, the bit 200 first contacts the second retainer 3, and the second retainer 3 is prevented from displacing by the locking surface 42 of the sleeve 4 and cannot move. Thus, the bit 200 cannot be pulled out.

When the bit 200 is removed, the sleeve 4 is pulled manually so that the sleeve 4 moves forward, the locking surface 42 is disengaged from the second retainer 3, and the second retainer 3 can move in the radial direction of the base 1. At this time, the bit 200 is pulled and pushes the first retainer 2 and the second retainer 3 to move outward to unlocking positions along the radial direction of the base 1 so that the bit 200 can be smoothly pulled out.

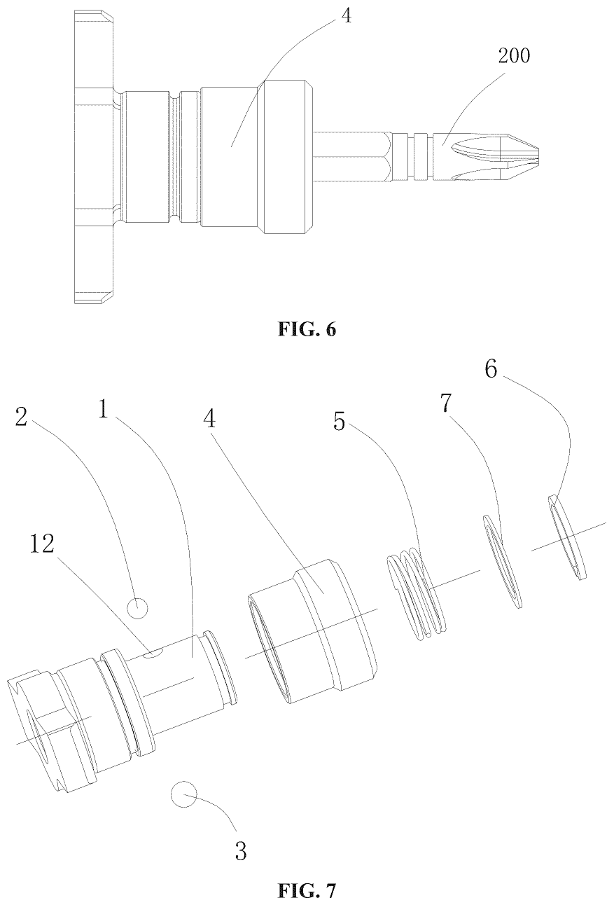

As shown in FIGS. 6 to 15, the present application further provides a mounting assembly for detachably fixing a bit, a bit 200 includes a groove 201, and the mounting assembly includes a base 1, a first retainer 2, a second retainer 3, a sleeve 4, and a biasing element 5.

The base 1 includes an axial opening 11 for receiving the bit 200 and a first circular hole 12 and a second circular hole 13 that are defined on a wall of the axial opening 11. The first retainer 2 is configured to move radially in the first circular hole 12; and the second retainer 3 is configured to move radially in the second circular hole 13. The sleeve 4 is sleeved on the periphery of the base 1, and the sleeve 4 includes an inclined surface 41. When the inclined surface 41 is pressed against, the sleeve 4 moves axially relative to the base 1. The biasing element 5 is disposed between the base 1 and the sleeve 4 to bias the sleeve 4 in position. When the bit 200 is locked in the axial opening 11, the first retainer 2 and the second retainer 3 are at least partially retained in the groove 201.

The first retainer 2 and the second retainer 3 are at least partially retained in the groove 201 so that the distance between the first retainer 2 and the second retainer 3 can be reduced as much as possible, further reducing the length of the base 1.

As shown in FIGS. 11 and 13, in some examples, the first retainer 2 and the second retainer 3 are spheres, and the second retainer 3 has a greater diameter than the first retainer 2. Since the bit 200 is cylindrical, the sleeve 4 includes the inclined surface 41 and a locking surface 42 connected to the inclined surface 41, where the locking surface 42 is a horizontal plane. Only when the first retainer 2 has a smaller diameter than the second retainer 3, can it be ensured that during the insertion of the bit 200, the bit 200 presses against the first retainer 2 so that the first retainer 2 mates with the inclined surface 41 of the sleeve 4, and the sleeve 4 moves towards an open end of the axial opening 11 to unlock the second retainer 3, and the bit 200 can push the second retainer 3 to move outward along a radial direction of the base 1 during the continued insertion. After the bit 200 is inserted into place, the first retainer 2 and the second retainer 3 are at least partially located in the groove 201, the sleeve 4 resets under the action of the biasing element 5, and the second retainer 3 mates with the locking surface 42 of the sleeve 4 so that the second retainer 3 is locked, thereby ensuring that the bit 200 is stably disposed in the base 1.

As shown in FIG. 13, in some examples, the biasing element 5 biases the sleeve 4 in an opposite direction of the axial opening 11. Under the action of the biasing element 5, the biasing element 5 mates with the second retainer 3 to lock the position of the second retainer 3 in the base 1. Without manually pulling the biasing element 5 for unlocking, the second retainer 3 can be kept in a locked state all the time. After the bit 200 is mounted, the position of the bit 200 can be stably locked.

As shown in FIGS. 6 to 15, the present application further provides a mounting assembly for detachably fixing a bit, a bit 200 includes a groove 201, and the mounting assembly includes a base 1, a first retainer 2, a second retainer 3, a sleeve 4, and a biasing element 5.

The base 1 includes an axial opening 11 for receiving the bit 200 and a first circular hole 12 and a second circular hole 13 that are defined on a wall of the axial opening 11, where the first circular hole 12 and the second circular hole 13 each communicate with the axial opening 11. The first retainer 2 is configured to move radially in the first circular hole 12. The second retainer 3 is configured to move radially in the second circular hole 13. The sleeve 4 is sleeved on the periphery of the base 1, and the sleeve 4 includes an inclined surface 41. When the inclined surface 41 is pressed against, the sleeve 4 moves axially relative to the base 1. The biasing element 5 is disposed between the base 1 and the sleeve 4 to bias the sleeve 4 in position. During the insertion of the bit 200 into the axial opening 11, the first retainer 2 moves outward and presses against the inclined surface 41 to move the sleeve 4 in a direction towards an open end of the axial opening 11; and after the bit 200 is completely inserted into the axial opening 11, the biasing element 5 resets the sleeve 4.

As shown in FIG. 13, in some examples, the second retainer 3 is configured to, after the bit 200 is inserted into the axial opening 11, move inward and abut against the groove 201 to lock the bit 200. After the bit 200 is inserted into place, the groove 201 of the bit 200 faces the second retainer 3, and the second retainer 3 automatically falls into the groove 201 and thus locks the bit 200. In this manner, a relative position between the bit 200 and the base 1 can be locked, and during the subsequent operation of the bit 200, the bit 200 does not fall out of the base 1, ensuring the stability of operation of the impact screwdriver 100.

As shown in FIGS. 11 and 13, in some examples, the sleeve 4 includes a locking surface 42 connected to the inclined surface 41, and after the bit 200 is inserted into the axial opening 11, the locking surface 42 is able to prevent the second retainer 3 from moving outward. The locking surface 42 is a horizontal plane. After the bit 200 is inserted into the axial opening 11, the second retainer 3 is at least partially located in the groove 201 of the bit 200. At this time, the sleeve 4 is reset, the locking surface 42 of the sleeve 4 abuts against the second retainer 3, and the locking surface 42 is a horizontal plane and thus prevents the second retainer 3 from moving in the radial direction of the base 1, thereby locking the position of the bit 200 relative to the base 1.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A mounting assembly for detachably fixing a bit, comprising:
a base, having an axial length less than or equal to 32 mm, comprising an axial opening for receiving a bit, the axial opening having a wall with the wall having a first circular hole and a second circular hole;
a first retainer configured to move radially in the first circular hole;
a second retainer configured to move radially in the second circular hole and having a greater volume than the first retainer;
a sleeve, sleeved on a periphery of the base, comprising an inclined surface which, when pressed against, causes the sleeve to move axially relative to the base; and
a biasing element, disposed between the base and the sleeve, to bias the sleeve into a predetermined position.

2. The mounting assembly according to claim 1, wherein the axial length of the base is greater than or equal to 27 mm and less than or equal to 31 mm.

3. The mounting assembly according to claim 1, wherein the first retainer is configured to, when the bit is inserted into the axial opening, move outward and press against the inclined surface to move the sleeve.

4. The mounting assembly according to claim 1, wherein the second retainer is configured to, after the bit is inserted into the axial opening, move inward and abut against a groove on the bit to lock the bit.

5. The mounting assembly according to claim 1, wherein the sleeve comprises a locking surface connected to the inclined surface, and, after the bit is inserted into the axial opening, the locking surface is able to prevent the second retainer from moving outward.

6. The mounting assembly according to claim 1, wherein, after the bit is inserted into the axial opening, the biasing element resets the sleeve.

7. The mounting assembly for detachably fixing a bit according to claim 1, wherein a shortest distance between the first circular hole and an open end of the axial opening is less than a shortest distance between the second circular hole and the open end of the axial opening.

8. The mounting assembly according to claim 1, wherein, when the sleeve is pulled manually, the second retainer and the first retainer are movable radially so that the bit is removeable.

9. The mounting assembly according to claim 1, wherein a bit ejection mechanism is provided in the axial opening, and the bit ejection mechanism is able to eject the bit through a set distance relative to an open end of the axial opening.

10. The mounting assembly according to claim 1, wherein a width of a groove on the bit is greater than a diameter of the first circular hole and a diameter of the second circular hole.

11. A mounting assembly for detachably fixing a bit, comprising:
a base comprising an axial opening for receiving a bit, the axial opening having a wall with the wall having a first circular hole and a second circular hole;
a first retainer configured to move radially in the first circular hole;
a second retainer configured to move radially in the second circular hole;
a sleeve, sleeved on a periphery of the base, comprising an inclined surface which, when pressed against, causes the sleeve to move axially relative to the base; and
a biasing element disposed between the base and the sleeve to bias the sleeve into a predetermined position;
wherein, when the bit is locked in the axial opening, the first retainer and the second retainer are at least partially retained in a groove on the bit.

12. The mounting assembly according to claim 11, wherein the first retainer and the second retainer are spheres, and the second retainer has a greater diameter than the first retainer.

13. The mounting assembly according to claim 11, wherein the biasing element biases the sleeve in an opposite direction of the axial opening.

14. A mounting assembly for detachably fixing a bit, comprising:
a base comprising an axial opening for receiving a bit, the axial opening having a wall with the wall having a first circular hole and a second circular hole;
a first retainer configured to move radially in the first circular hole;
a second retainer configured to move radially in the second circular hole;
a sleeve, sleeved on a periphery of the base, comprising an inclined surface which, when pressed against, causes the sleeve to move axially relative to the base; and
a biasing element disposed between the base and the sleeve to bias the sleeve into a predetermined position;
wherein, during insertion of the bit into the axial opening, the first retainer moves outward and presses against the inclined surface to move the sleeve and, after the bit is completely inserted into the axial opening, the biasing element resets the sleeve.

15. The mounting assembly according to claim 14, wherein the first retainer and the second retainer are spheres, and the second retainer has a greater diameter than the first retainer.

16. The mounting assembly according to claim 14, wherein the biasing element biases the sleeve in an opposite direction of the axial opening.

17. The mounting assembly according to claim 14, wherein the second retainer is configured to, after the bit is inserted into the axial opening, move inward and abut against a groove on the bit to lock the bit.

18. The mounting assembly according to claim 14, wherein the sleeve comprises a locking surface connected to the inclined surface, and after the bit is inserted into the axial opening, the locking surface is able to prevent the second retainer from moving outward.

19. The mounting assembly according to claim 14, wherein a width of a groove on the bit is greater than a diameter of the first circular hole and a diameter of the second circular hole.

20. The mounting assembly according to claim 14, wherein a bit ejection mechanism is provided in the axial opening, and the bit ejection mechanism is able to eject the bit through a set distance relative to an open end of the axial opening.
